(19) United States
(12) Patent Application Publication
(10) Pub. No.: US 2019/0222309 A1
(43) Pub. Date: Jul. 18, 2019

(54) SYSTEM AND A METHOD FOR DETECTING THE INSTALLATION OF AN OPTICAL TAP AND A METHOD OF SECURING AN OPTICAL SIGNAL IN AN OPTICAL FIBER

(71) Applicant: MACQUARIE UNIVERSITY, North Ryde, NSW (AU)

(72) Inventors: Simon GROSS, Waverton, NSW (AU); Michael WITHFORD, Ingleside, NSW (AU)

(21) Appl. No.: 16/324,511

(22) PCT Filed: Aug. 9, 2017
(86) PCT No.: PCT/AU2017/050836

§ 371 Date: Feb. 8, 2019

(30) Foreign Application Priority Data
Aug. 9, 2016 (AU) 2016903123

(51) Int. Cl. H04B 10/07; H04B 10/073

(52) U.S. Cl. CPC H04B 10/0705; H04B 10/073

(57) ABSTRACT

A system for detecting the installation of an optical tap on an optical fiber link. The system comprises a spatial mode de-multiplexer optically coupled to the optical fiber link. The spatial mode de-multiplexer is configured to isolate an optical signal in a first spatial mode of the optical fiber link. The spatial mode de-multiplexer is configured to isolate light in a second spatial mode of the optical fiber link 14. The system comprises an optical sensor optically coupled to the spatial mode de-multiplexer for measuring the optical power of the light in the second spatial mode of the optical fiber link. Also disclosed herein are methods for detecting installation of an optical tap and methods for securing an optical signal in an optical fiber.

### PRIORITY CLAIM

The present application is a National Phase entry of PCT Application No. PCT/AU2017/050836, filed Aug. 9, 2017, which claims the benefit of Australian Patent Application No. 2016903123, filed Aug. 9, 2016, which are incorporated herein by reference.

### FIELD OF THE INVENTION

The disclosure herein generally relates to a system and a method for detecting the installation of an optical tap and a method of securing an optical signal in an optical fiber.

### BACKGROUND

Unauthorized access to an optical signal within an optical fiber link may be achieved relatively easily without detection. The optical signal may contain sensitive personal, commercial, national or military information, for example, that must not be available to unauthorized persons. Unauthorized access may cause harm, casualties in the case of sensitive military information, or embarrassment. Many organizations may not be aware of possible or actual unauthorized access.

Physical layer security, for example metal jacketed cables, may be implemented to discourage unauthorized optical tapping. Unauthorized persons, however, have a variety of optical tapping methods and may circumvent jacketed cables.

Some methods of securing optical fiber links include the use of a secondary dark fiber to detect intrusion in a fiber optic conduit, phase modulation, wavelength differentiated sensing or sophisticated transmission protocols. These techniques, however, may generally be for single mode fibers and may require expensive monitoring electronics.

Improved methods of detecting unauthorized optical tapping of an optical fiber link may be welcomed.

An optical fiber link may comprise multimode optical fiber. Multimode optical fibers support a plurality of spatial modes. The plurality of spatial modes that a multimode optical fiber supports may depend on the geometry, index contrast, and other parameters. A multimode fiber that only supports no more than a few spatial modes is commonly known as a “few moded fiber”. Example conventional labels for a selection of spatial modes that may be found in a multimode fiber include: LP₀₁ (The fundamental, zero order mode), LP₁₁, LP₂₁, LP₀₂, LP₃₁, LP₁₂, LP₄₁, LP₂₂, LP₀₃, LP₅₁, LP₃₂, LP₆₁, LP₁₃, and LP₄₂ (higher order modes), and degeneracies thereof, for example LP₁₁ₐ and LP_{11b}. FIGS. 1 and 2 shows graphs of normalized propagation constants versus fiber parameter for each of the above mentioned modes in a step index fiber and a graded index fiber.

### SUMMARY

Disclosed herein is a method for detecting installation of an optical tap on an optical fiber link, the method comprising the steps of:

launching into the optical fiber link an optical signal in a first spatial mode of the optical fiber link; and

monitoring the optical power of light in a second spatial mode of the optical fiber link.

In an embodiment, the mode order of the second spatial mode is greater than that of the first spatial mode.

In an embodiment, the first mode has a mode order of 0.

In an embodiment, the optical signal has a wavelength greater than the optical fiber link's cut-off wavelength.

In an embodiment, the light has a wavelength less than the optical fiber link's cut-off wavelength.

In an embodiment, the step of launching into the optical fiber link the optical signal comprises launching the optical signal only into the first spatial mode of the optical fiber link.

In an embodiment, installation of the optical tap causes a portion of the optical signal in the first spatial mode of the optical fiber link to couple into the second spatial mode of the optical fiber link.

In an embodiment, the step of generating a trigger signal when the optical power of the light in the second spatial mode of the optical fiber link satisfies a trigger condition.

In an embodiment, monitoring the optical power of the light comprises monitoring the optical power of light in at least one of the second spatial mode of the optical fiber link and a third spatial mode of the optical fiber link.

In an embodiment, the mode order of the third spatial mode is greater than that of the first spatial order.

In an embodiment, installation of the optical tap causes a portion of the optical signal in the first spatial mode of the optical fiber link to couple into the third spatial mode of the optical fiber link.

An embodiment comprises the step of generating a trigger signal when a change in the optical power of the light in at least one of the second spatial mode of the optical fiber link and the third spatial mode of the optical fiber link satisfies a trigger condition.

An embodiment comprises the steps of:

launching a monitoring light into the second spatial mode of the optical fiber link;

monitoring the optical power of the monitoring light in the second spatial mode of the optical fiber link, whereby installation of the optical tap changes the optical power of the monitoring light in the second spatial mode, wherein the light comprises the monitoring light.

In an embodiment, the step of launching the monitoring light comprises the step of launching the monitoring light only into the second spatial mode of the optical fiber link.

In an embodiment, monitoring the optical power of the monitoring light comprises the step of monitoring the optical power of the monitoring light in at least one of the second spatial mode and a third spatial mode of the optical fiber link, whereby installation of the optical tap changes the optical power of the monitoring light in each of the second spatial mode and the third spatial mode.

In an embodiment, installation of the optical tap changes the optical power of the monitoring light in each of the second spatial mode and the third spatial mode.

In an embodiment, the propagation constants of the second spatial mode and third spatial mode are more similar then either the propagation constants of the first spatial mode and second spatial mode or the propagation constants of the first spatial mode and third spatial mode.

An embodiment comprises the step of generating a trigger signal when a change in the optical power of the monitoring light in the second spatial mode satisfies a trigger condition.

In an embodiment, the step of generating the trigger signal comprises generating the trigger signal when a change in the optical power of the monitoring light in at least one of the second spatial mode and a third spatial mode satisfies a trigger condition.

In an embodiment, the optical signal has a wavelength that is different than that of the monitoring light.

In an embodiment, the optical signal has a wavelength in a transmission window of the optical fiber link and the monitoring light has a wavelength out of the transmission window.

In an embodiment, the optical signal and the monitoring light have substantially the same wavelength.

In an embodiment, the monitoring light comprises a jamming signal.

In an embodiment, the jamming signal comprises at least one of a random data stream and a pseudo random data stream.

In an embodiment, the monitoring light does not comprise information within the optical signal.

In an embodiment, the optical fiber link is single moded at a wavelength of the optical signal and the optical fiber link is multimoded at a wavelength of the monitoring light.

In an embodiment, the optical fiber link is a step-index optical fiber link.

An embodiment comprises the step of optically coupling an optical time domain reflectometer to the optical fiber link for determining the position of an installed tap.

Disclosed herein is a system for detecting the installation of an optical tap on an optical fiber link. The system comprises a de-multiplexer optically coupled to the optical fiber link and configured to: (a) isolate an optical signal in a first spatial mode of the optical fiber link, and (b) isolate light in a second spatial mode of the optical fiber link. The system comprises an optical sensor optically coupled to the de-multiplexer to measure the optical power of the light in the second spatial mode when so isolated.

In an embodiment, the mode order of the second spatial mode is greater than the mode order of the first spatial mode.

In an embodiment, the first spatial mode has a mode order of 0.

In an embodiment, the optical signal has an optical wavelength greater than the optical fiber link's cut-off wavelength.

In an embodiment, the light has an optical wavelength less than the optical fiber link's cut-off wavelength.

In an embodiment, installation of the optical tap causes a portion of the optical signal in the first spatial mode of the optical fiber link to couple into the second spatial mode of the optical fiber link.

An embodiment comprises a trigger signal generator in information communication with the optical sensor and configured to generate a trigger signal when sensor generated information received thereby is indicative of an optical power of the light in the second spatial mode satisfying a trigger condition.

An embodiment comprises a multiplexer optically coupled to the optical fiber link and configured for launching into the optical fiber link the optical signal in the first spatial mode and launching the light into the second spatial mode.

In an embodiment, the multiplexer is configured for launching into the optical fiber link the optical signal in only the first spatial mode and launching the light into only the second spatial mode.

In an embodiment, the multiplexer comprises a spatial mode multiplexer.

In an embodiment, the multiplexer comprises a wavelength division multiplexer operatively coupled to the spatial mode multiplexer.

In an embodiment, the optical signal and the light have different optical wavelengths.

In an embodiment, the multiplexer comprises a photonic chip.

In an embodiment, the de-multiplexer comprises a spatial mode de-multiplexer.

In an embodiment, the de-multiplexer comprises a wavelength division de-multiplexer.

In an embodiment, the de-multiplexer comprises a photonic chip.

In an embodiment, the light comprises a monitoring light that does not comprise information within the optical signal.

In an embodiment, the de-multiplexer is configured to isolate light in at least one of the second spatial mode of the optical fiber link and a third spatial mode of the optical fiber link.

In an embodiment, the mode order of the third spatial mode is greater than that of the first spatial order.

In an embodiment, installation of the tap changes the optical power of the light in each of the second spatial mode and the third spatial mode.

In an embodiment, the optical sensor is optically coupled to the de-multiplexer to measure the optical power of the light in at least one of the second mode and the third spatial mode. The trigger signal generator may be configured to generate a trigger signal when sensor generated information received thereby is indicative of an optical power of the light in at least one of the first spatial mode and the second spatial mode satisfies a trigger condition.

In an embodiment, the propagation constants of the second spatial mode and the third spatial mode are more similar then either the propagation constants of the first spatial mode and the second spatial mode or the propagation constants of the first spatial mode and third spatial mode.

An embodiment comprises an optical time domain reflectometer in optical communication with the spatial mode multiplexer for detecting the position of the optical tap when so installed.

An embodiment comprises an optical time domain reflectometer in optical communication with the de-multiplexer for determining the position of the optical tap when so installed.

In an embodiment, the optical fiber link is a step index optical fiber link.

Disclosed herein is a method of securing an optical signal in an optical fiber. The method comprises the step of launching into a first spatial mode of the optical fiber link an optical signal. The method comprises the step of launching into a second spatial mode of the optical fiber link a jamming optical signal comprising a wavelength component substantially identical to a wavelength component of the optical signal.

In an embodiment, the jamming signal comprises at least one of a random data stream and a pseudo random data stream.

Any of the various features of each of the above disclosures, and of the various features of the embodiments described below, can be combined as suitable and desired.

### BRIEF DESCRIPTION OF THE DRAWINGS

Embodiments will now be described by way of example only with reference to the accompanying figures in which:

FIGS. 1 and 2 shows graphs of normalized propagation constants versus normalized frequency for step index and graded index optical fibers respectively (prior art).

FIG. 3 shows a schematic diagram of an embodiment of a system for detecting the installation of an optical tap on an optical fiber link.

FIG. 4 shows a schematic diagram of another embodiment of a system for detecting the installation of an optical tap on an optical fiber link.

FIG. 5 shows a schematic of the system of FIG. 4 during installation of an optical tap.

FIG. 6 shows a schematic diagram of another embodiment of a system for detecting the installation of an optical tap on an optical fiber link.

FIG. 7 shows a schematic diagram of another embodiment of a system for detecting the installation of an optical tap on an optical fiber link.

FIG. 8 shows a schematic diagram of an embodiment of a photonic device, in the form of a photonic chip.

FIG. 9 shows an elevational view of the waveguide network within an example of a photonic chip, and a graph of effective refractive index therein.

FIG. 10 shows an elevational view of the waveguide network within another example of a photonic chip, and a graph of effective refractive index therein.

FIG. 11 shows an elevational view of a waveguide network within yet another example of a photonic chip, and a graph of effective refractive index therein.

FIGS. 12 and 13 shows flow diagrams of embodiments of a method for detecting installation of the optical tap on the optical fiber link.

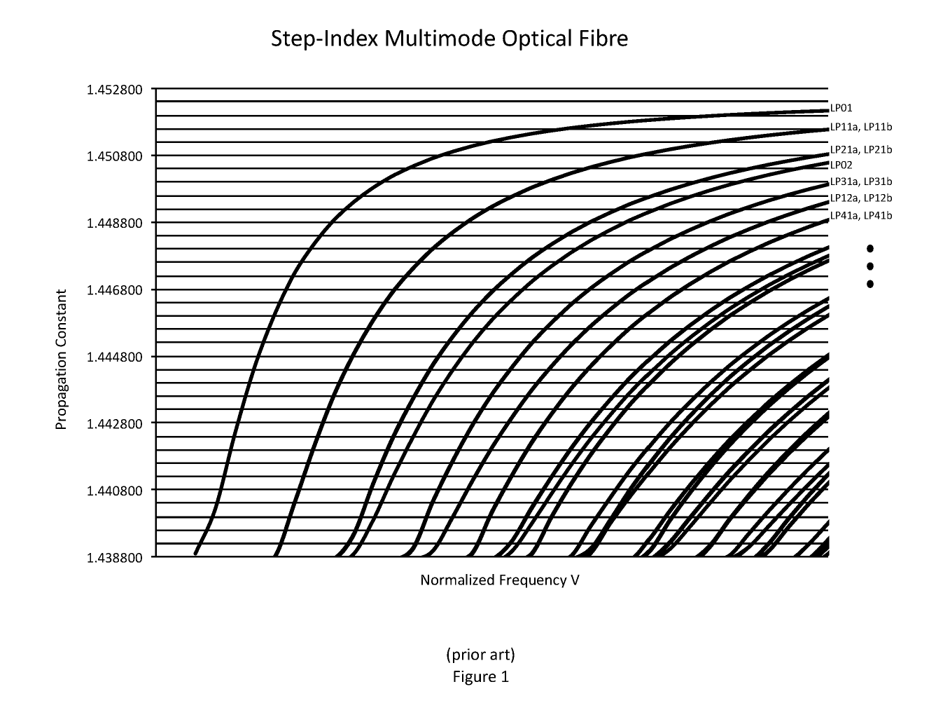

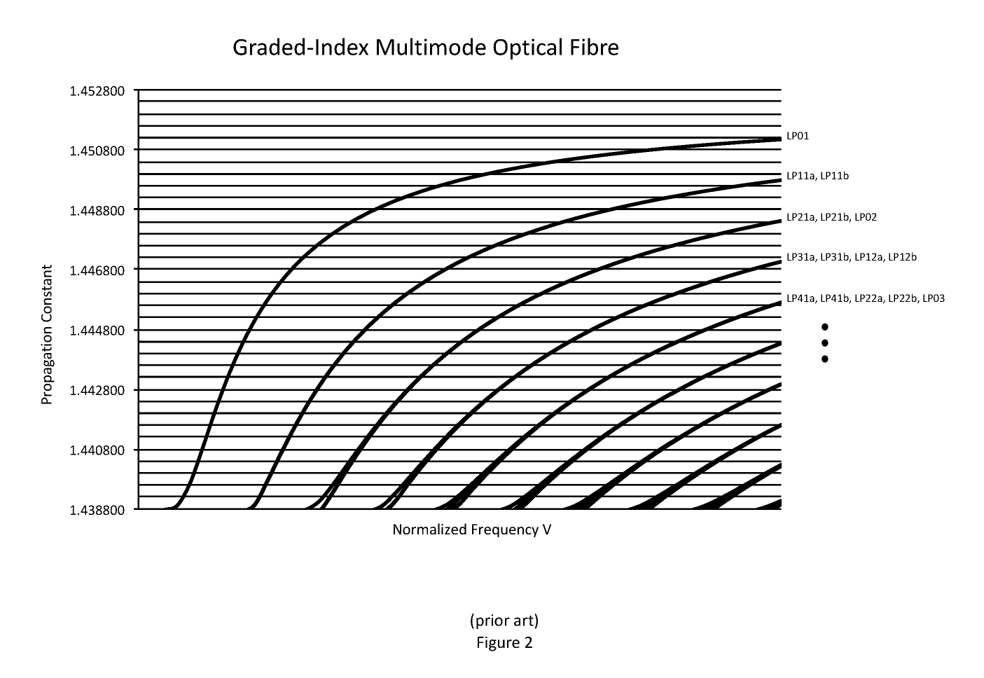

### DETAILED DESCRIPTION

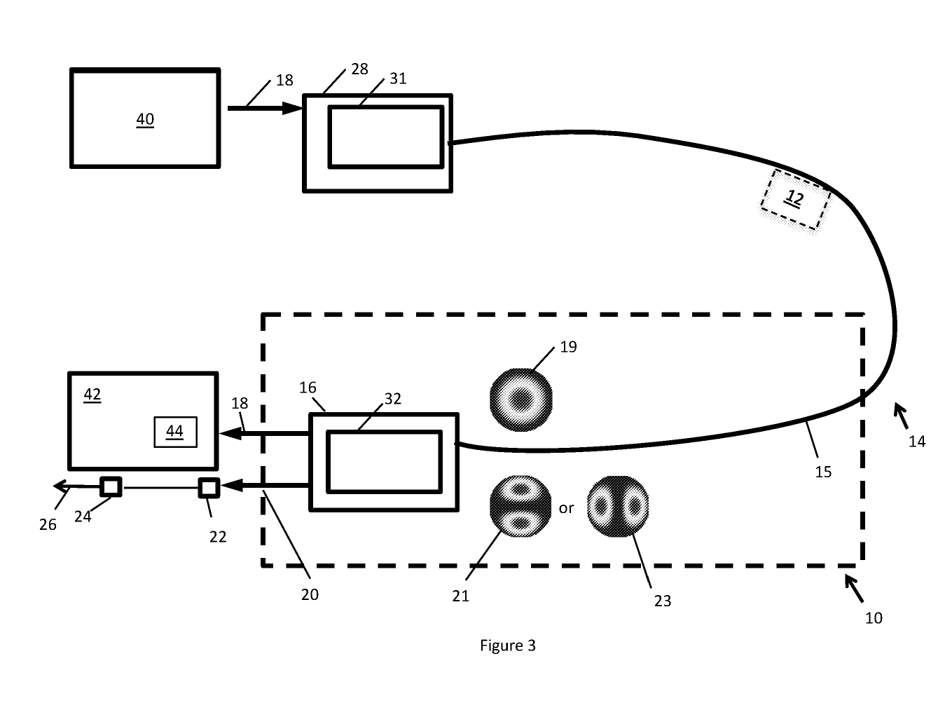

FIG. 3 shows a schematic diagram of an embodiment of a system, generally indicated by the numeral 10, for detecting the installation of an optical tap 12 on an optical fiber link 14. The system 10 comprises a demultiplexer 16 in the form of a spatial mode de-multiplexer optically coupled to the optical fiber link 14. The de-multiplexer 16 is configured to isolate an optical signal 18 in a first spatial mode 19 of the optical fiber link 14. The de-multiplexer 16 is configured to isolate light 20 in a second spatial mode 21 of the optical fiber link 14. The system 10 comprises an optical sensor 22 optically coupled to the de-multiplexer 16 for measuring the optical power of the light 20 in the second spatial mode of the optical fiber link 14.

Generally, but not necessarily, the optical signal is confined to the first spatial mode of the optical fiber link 14. Confining the optical signal to the first spatial mode reduces optical signal dispersion, which generally allows for a longer optical fiber link. Secure communications may be achieved for optical fiber links of at least one of greater than 10 km and greater than 30 km. These optical fiber link lengths may be found in defence complexes, campuses, government and private facilities, central business districts, and optical fiber links linking the CBD to its surrounds. Preinstalled optical fiber and optical fiber cables which embodiments may exploit are common, and so embodiments may be commonly installed on pre-existing optical fiber and optical fiber cable. This may eliminate the need to install special optical fiber links.

The optical signal 18 comprises information that is being communication from an information source 40 to an information destination 42. The optical signal 18 that is isolated by the de-multiplexer 16 may be detected by an optical detector 44 in the form of a photodiode for retrieval of the information, or it may be launched into another optical fiber link, for example.

The tap 12 may operate by bending an optical fiber carrying the optical signal within an optical fiber cable to cause the optical signal to leak from the optical fiber. For example, the cable cladding may be breached to expose the optical fiber, and a bend in the form of a microbend formed in the exposed optical fiber. The microbend may be formed by pressing a blade, for example, against the exposed optical fiber. Light leaks from the optical fiber 15 were the blade meets it and may be detected by a photodiode adjacent the point that the blade meets the optical fiber 15. The installation of generally any suitable tap, however, may be detected.

Installation of the optical tap 12 may cause a portion of the optical signal 18 in the first spatial mode of the optical fiber link to couple into the second spatial mode 21 of the optical fiber link, the optical signal 18 so coupled being the light in the second spatial mode 21 of the optical fiber link. Normally, there may not be light in the second spatial mode, so detection of light therein may be indicative of a tap.

In the present but not all embodiments, the de-multiplexer 16 is configured to isolate light in a third spatial mode 23 of the optical fiber link. Light from the second spatial mode may be coupled into the third spatial mode. The sensor 22 may detect light in the second spatial mode 21 and/or the third spatial mode 23. The sensor may, for example, receive light from one of the second 21 and third 23 spatial modes, or both the second 21 and third 23 spatial modes. The light from the second 21 and third 23 spatial modes may be individually detected by the sensor 22, or light from the second 21 and third 23 spatial modes may be separately detected by the sensor 22, which may but not necessarily comprise distinct light sensitive sensor elements for the light in the second 21 spatial mode and the light in the third 23 spatial mode.

The multiplexer 16 may comprise a photonic chip 32, as the present embodiment has, although alternative embodiments may comprise a fiber de-multiplexer, a planar de-multiplexer, or generally any suitable form of multiplexer.

An embodiment comprises a trigger signal generator 24 in communication with the optical sensor 22 and configured to generate a trigger signal 26 when the optical power of the light, including a change in the optical power of the light, in at least one of the second spatial mode 21 and the third spatial mode 23 satisfies a trigger condition. The de-multiplexer 16 may have an optical fiber pigtail for communicating the light 20 to the optical sensor 22. Alternatively, bulk optics may be used to communicate the light 20 to the sensor 22. For example, in the present but not all embodiments, the optical sensor 22 may measure the optical power of the light in the second spatial mode 21, and optical power information is electrically communicated from the sensor to the trigger signal generator 24. The trigger signal generator 24 is configured to generate the trigger signal 28 when the optical power information is indicative of an optical power greater than a threshold optical power, however other trigger conditions may be used. In the present embodiment, the trigger signal generator 24 comprises a processor having non-transitory processor readable tangible media including program instructions which when executed by a processor causes the processor to monitor the received optical power information from the sensor 22 and generate a visual alert on an electronic display when the optical power is greater than a threshold optical power. Alternatively or additionally, the program instructions may ne to cease transmission of the optical signal 20 when the trigger signal is generated.

The system 10 may comprise an optional multiplexor 28 in the form of a spatial mode multiplexer to launch the optical signal onto the first spatial mode, which is generally the fundamental spatial mode of the optical fiber link 14. Normally there would be little or no coupling of the optical signal in the first spatial mode 19 into other spatial modes, for example either the second spatial mode 21 or the third spatial mode 23. In this embodiment, the installation of a tap causes the optical signal 18 launched into the single spatial mode 19 to leak into at least one of the second spatial optical mode 21 and the third spatial optical mode 23, and detection of light isolated from either one of the second or third spatial mode is indicative of an installed tap. The optical signal may leak into the second spatial mode 21 and/or the third spatial optical mode 23 for microbends that cause a sharp core displacement if less than 50 μm. Leakage may also occur when the fiber is bent to a radii less than 10 mm. In this embodiment, there is no additional monitoring light that is launched into the optical fiber link 14 for detecting installation of the optical tap, however otherwise identical embodiments may have the additional monitor light so launched. The larger the core displacement, the higher the order of the mode that the light is coupled into. A sharp core displacement of at least 20 μm will cause coupling into a second order spatial mode.

The multiplexor 28 comprises a photonic chip 31, as the present embodiment has, however alternative embodiments may comprise a fiber de-multiplexer. The photonic chip 31 of the multiplexer 28 is, in this but not all embodiments, identical to the photonic chip 32 at the de-multiplexer.

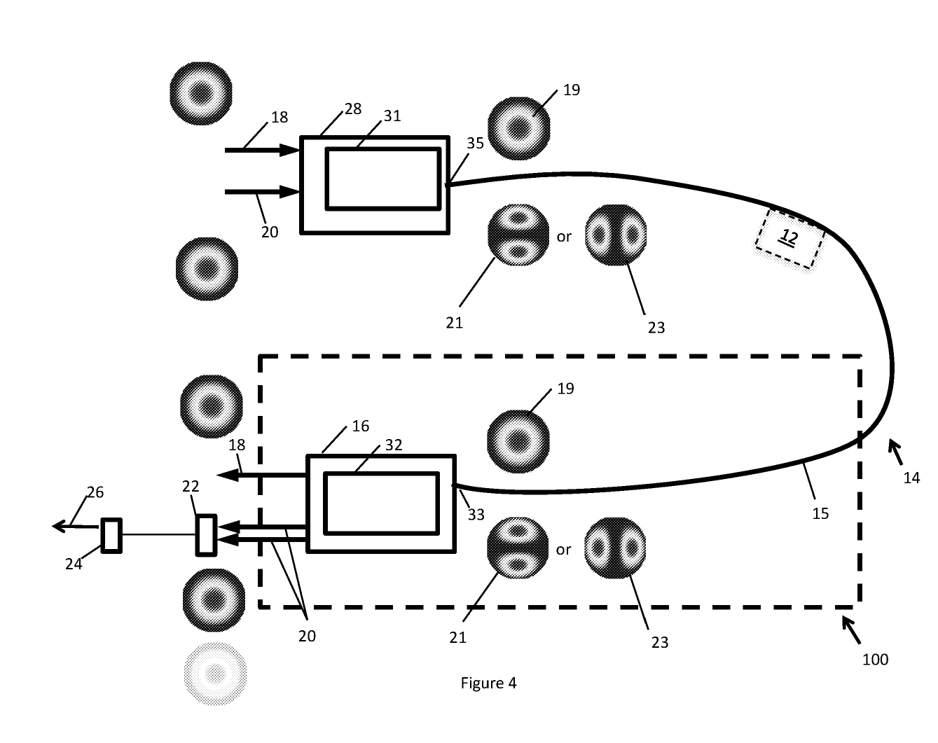

FIG. 4 shows a schematic diagram of another embodiment of a system 100, for detecting the installation of an optical tap 12 on an optical fiber link 14, for example. Parts having similar and/or identical function and/or form to those in FIG. 3 are similarly number. The system 100 comprises a de-multiplexer 16 in the form of a spatial-mode de-multiplexer optically coupled to the optical fiber link 14. The de-multiplexer 16 is configured to isolate an optical signal 18 in a first spatial mode 19 of the optical fiber link 14. The de-multiplexer 16 is configured to isolate monitoring light 20 in at least one of a second spatial mode 21 of the optical fiber link 14 and a third spatial mode 23 of the optical fiber link 14. The system 100 comprises an optical sensor 22 optically coupled to the de-multiplexer 16 for measuring the optical power of the monitoring light 20 in at least one of the second spatial mode of the optical fiber link 14 and the third spatial mode of the optical fiber link 14. The sensor may measure the optical power in (a) one of the second and third spatial mode, or (b) both the second and third spatial mode. Mode coupling in the optical fiber link 14 and/or installation of the optical tap 12 changes the proportion of the monitoring light 20 in at least one of the second spatial 21 mode and the third spatial mode 23. Generally, but not necessarily, the optical signal is confined to the first spatial mode of the optical fiber link 14. The monitoring signal is launched, in this but not all embodiments, into only the second spatial mode of the optical fiber link 14. The monitoring signal may be launched into any higher order mode of the optical fiber link. The coupling and/or leakage increases with the spatial mode order, which can be used to increase sensitivity. The propagation losses, however, increase with mode order and consequently for fiber links greater than, say, 1 km, the monitoring signal may be launched into a lower order higher spatial mode (e.g. LP₁₁ and/or LP₂₁), for example the lowest order higher spatial mode (e.g. LP₁₁). For differential detection in the case of a step index fiber, the monitoring signal may be launched into a degenerate spatial mode. In the case of a graded-index fiber, the light may be launched into any mode or part of a mode group.

The optical signal 18 comprises information that is being communicated from an information source to an information destination. The optical signal 18 that is isolated from by the de-multiplexer may be detected by an optical detector for retrieval of the information, or it may be launched into another optical fiber link, for example.

The monitoring light is not, at least in this embodiment, launched into the first spatial mode. The coupling of the monitoring light 20 between the second spatial mode 21 and the third spatial mode 23 changes during installation of the optical tap 12. Detection of a change in the proportion of light (“power ratio”) in the second spatial mode 21 and the third spatial mode 23 is generally indicative of an installed optical tap. The monitoring light may leak into the third spatial mode or leak out of the fiber and be lost when the tap 12 is installed. The second spatial mode and the third spatial mode each have a higher mode order than the first spatial mode. Consequently, the second spatial mode and the third spatial mode are more sensitive to installation of a tap than the first spatial mode. The installation may be detected before a detectable amount of the optical signal leaks from the optical fiber.

The de-multiplexer 16 may have an optical fiber pigtail for communicating the light to the optical sensor 22. Alternatively, bulk optics may be used to communicate the light to the sensor 22. For example, the optical sensor 22 may measure the optical power of the light in the second spatial mode 21, and optical power information is electrically communicated from the sensor to the trigger signal generator 24. The trigger signal generator 24 is configured to generate the trigger signal 28 when the optical power information is indicative of an optical power greater than a threshold optical power. In the present embodiment, the trigger signal generator comprises a processor having non-transitory processor readable tangible media including program instructions which when executed by a processor causes the processor to monitor the received optical power information and generate a visual alert on an electronic display when the optical power is greater than a threshold optical power. Alternatively or additionally, the program instructions may ne to cease transmission of the optical signal 20 when the trigger signal is generated.

Optical fibers have transmission windows or bands. These may be defined, for example, as in Table 1, however other wavelength ranges may be stated for alternative definitions. In the embodiments of FIGS. 3 to 6, for example, the optical fiber link 14 comprises optical fiber 15 that has a single spatial mode (“single moded fiber”) in the Table 1 bands. In the illustrated embodiments, the optical fiber is compliant with recommendation G.652 (11/2016) Characteristics of a single-mode optical fiber and cable of the International Telecommunication Union (ITU) as set out in Table 2, as is the corresponding optical fiber cable, and is in the form of SMF-28 fiber by CORNING. Generally, any suitable step-index fiber may be used.

TABLE 1
A standard definition of transmission windows in optical
fiber communications.

| Band | Description | Wavelength Range |
|---|---|---|
| O band | Original | 1260 to 1360 nm |
| E band | Extended | 1360 to 1460 nm |
| S band | Short wavelengths | 1460 to 1530 nm |
| C band | Conventional (“erbium window”) | 1530 to 1565 nm |
| L band | Long wavelengths | 1565 to 1625 nm |
| U band | Ultra-long wavelengths | 1625 to 1675 nm |

TABLE 2
ITU-T G.652.B ATTRIBUTES

| | | | |
|---|---|---|---|
| Attribute | Detail | Value | Unit |

Fibre attributes

| | | | |
|---|---|---|---|
| Mode field diameter | Wavelength | 1310 | nm |
| | Range of nominal | 8.6-9.5 | μm |
| | values | | |
| | Tolerance | ±0.6 | μm |
| Cladding diameter | Nominal | 125.0 | μm |
| | Tolerance | ±1 | μm |
| Core concentricity error | Maximum | 0.6 | μm |
| Cladding non-circularity | Maximum | 1.0 | % |
| Cable cut-off wavelength | Maximum | 1260 | nm |
| Macrobending loss | Radius | 30 | mm |
| | Number of turns | 100 | |
| | Maximum at 1625 nm | 0.1 | dB |
| Proof stress | Minimum | 0.69 | GPa |
| Chromatic dispersion | λ₀ₘᵢₙ | 1300 | nm |
| parameter | λ₀ₘₐₓ | 1324 | nm |
| | S₀ₘₐₓ | 0.092 | ps/(nm² × |
| | | | km) |

Cable attributes

| | | | |
|---|---|---|---|
| Attenuation coefficient | Maximum at 1310 nm | 0.4 | dB/km |
| (Note 1) | Maximum at 1550 nm | 0.35 | dB/km |
| | Maximum at 1625 nm | 0.4 | dB/km |
| PMD coefficient | M | 20 | cables |
| (Note 2, 3) | Q | 0.01 | % |
| | Maximum PMD_{Q} | 0.20 | _{ps/}\sqrt{km} |

G.652 optical fibers and step index optical fibers are widely installed, and embodiments may be used with a substantial fraction of the installed optical fiber infrastructure. The optical signal may be in any of the bands in Table 1 for a G.652 optical fiber cable or optical fiber, and may generally have a wavelength greater than the cut-off wavelength for the optical fiber or optical fiber cable it is communicated by. In this case, the optical signal is in a single mode. Other embodiments, however, may comprise non-compliant optical fiber and cable, or optical fibers and cables of other standards and recommendations, for example dispersion shifted fibers, and fibers compliant with ITU-T G.655.

The optical signal's single spatial mode is the LP₀₁ mode in the illustrated embodiments. The spatial profile of the optical signal 18 and the monitoring light 20 at various points in embodiments is illustrated. The optical signal 18 has a wavelength in the C band, for example 1550 nm, however generally any suitable wavelength (for example in the O or another band) may be used. The optical fiber 15 is multimoded at a wavelength outside of the C band, for example for the monitoring light 20 which in the illustrated embodiments has a wavelength of 980 nm, although other suitable wavelengths may be used. The monitoring light may generally have a wavelength that is less than that of the optical signal such that the optical fiber link is multimode at the wavelength of the monitoring light. That is, the monitoring light of the illustrated embodiments has a wavelength that is less than the cut-off wavelength for the optical fiber 15 or optical fiber cable 14. The monitoring light 20 may, however, have any suitable wavelength. The monitoring light 20 is supported within the optical fiber link 14 by a second spatial mode which may, for example, comprise LP₁₁ₐ. A third spatial mode may be, for example, LP_{11b} mode, however any suitable spatial modes may be used. The power in one of the second and third spatial modes is expected to be greater than the power in the other when the fiber is unperturbed.

Some embodiment comprises a spatial mode multiplexer 28 optically coupled to the optical fiber link 14. The spatial mode multiplexer 28 may be configured for launching into the optical fiber link 14 the optical signal 18 into the first spatial mode. The spatial mode multiplexer 28 may be configured to launch the monitoring light 20 into at least one of the second spatial mode and the third spatial mode. The power of the monitoring light 20 is expected to be predominantly in one of the second and third modes. The spatial mode multiplexer may comprise a photonic chip 31.

The propagation constant of the second spatial mode and third spatial mode are, in this but not necessarily in all embodiments, more similar then either the propagation constants of the first and second spatial modes or the propagation constants of the first and third spatial modes. Light in one mode may be more easily coupled into another mode having a similar propagation constant. Perturbations to the optical fiber link, for example by installation of the tap, may increase the coupling of the light between modes having similar propagation constants. In a circularly symmetric multimode optical fiber, linear polarisation modes LPₗₘ are determined by their azimuthal order l and their radial order m. In the above described embodiment, the first spatial mode has a mode order of 0, and the second spatial mode and the third spatial mode each have a mode order of greater than 0, for example 1.

Generally, the magnitude of the optical power coupling increases with mode order, making higher order spatial modes more sensitive to perturbations. The order of the second and third spatial modes may be 2, 3, 4 or greater if more sensitivity is required.

The system 100 has a trigger signal generator 24 in communication with the optical sensor 22. The trigger signal generator 24 is configured to generate a trigger signal 26 when an optical power of the monitoring light 20, including a change in the optical power of the monitoring light, in at least one of the second spatial mode and the third spatial mode satisfies a trigger condition. The trigger signal may trigger an alert in the form of, for example, an indicator light, a graphic user interface displaying alert text or an alert symbol, and an audible alert, for example. Generally, the alert may take any suitable form. The trigger signal 26 may trigger another event, for example stopping the optical signal 18 so that information is not extracted by the tap 12. For example, the trigger condition may be that the optical power in the second (or third spatial mode) decreases or increases by more than at least one of 1%, 10%, 50%, and 90. The change may be in a period specified by the condition. The period may be, for example, no more than 1 μs, 1 ms, 0.1 s, 1 s, 10 s, 1 min, or 1 hour, or may be less than or greater than one of these values. Such a trigger condition may be indicative of installation of an optical tap 12 on the optical fiber link 14.

The trigger signal generator 24 may receive power information from an optical sensor 22,23 for more than the second spatial mode (e.g. the optical power information for the third spatial mode), and use the power information when generating the trigger signal. This may reduce the incidence of false alarms and/or increase detection sensitivity.

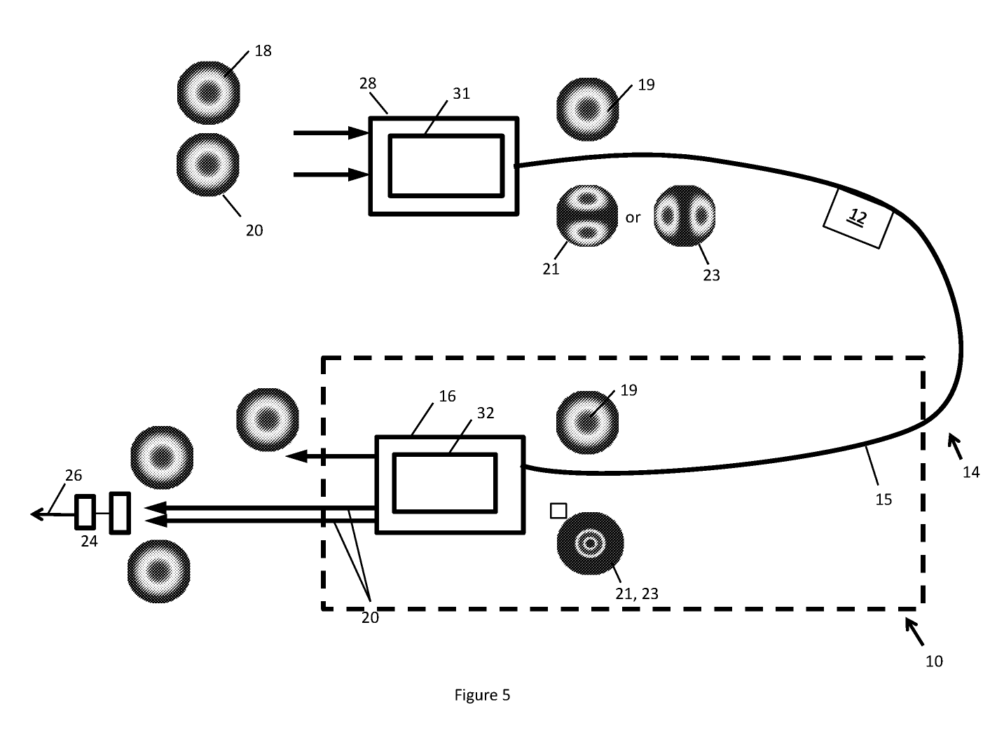

FIG. 5 shows a schematic of the system of FIG. 4 wherein, the optical fiber 15 of the optical fiber link 14 is bent during installation of the optical tap 12. The bend, which may be in the form of a microbend, is from the optical tap being installed. Another form of optical tapping may be achieved by etching the cladding of the optical fiber 15. Both of these optical tapping techniques may induce power changes to the second spatial mode 21 and/or the third spatial mode 23. The sensed distribution of power in the LP₁₁ₐ and LP_{11b} modes has changed such that a trigger condition is satisfied and the trigger signal 26 generated. A power ratio approaching 1 is expected depending on perturbation to the fiber because of power sharing between LP₁₁ₐ and LP_{11b} producing an annular intensity distribution at the monitor wavelength.

The optical signal 18 is launched into the multiplexer 28. The optical signal in this embodiment, but not necessarily, may have a substantially lowest order pre-launch spatial mode profile (e.g. Gaussian). The multiplexer is configured in this but not all embodiments to communicate the optical signal 19 therethough in the lowest order mode. The monitoring light 20 is launched into the multiplexer 28. The monitoring light may have a substantially lowest order pre-launch spatial mode profile. The multiplexer 28 couples the monitoring light 20 into a higher order spatial mode, in this embodiment LP₁₁ₐ, within the multiplexer, however it may be LP_{11b} or generally any suitable higher order spatial mode profile. The multiplexer 28 couples the monitoring light 20 in the higher order spatial mode and the optical signal 18 into the same fiber 15 of the optical fiber link 14 such that the monitoring light 20 is launched into the higher order spatial mode of the optical fiber link 14 and the optical signal is launched into the lowest order spatial mode of the optical fiber link 14.

While in the embodiment of FIGS. 3 to 5 the optical signal 18 has a wavelength that is different than that of the monitoring light 20, in another embodiment the monitoring light 20 and optical signal 18 have substantially the same wavelength (which encompasses the monitoring light 20 and optical signal 18 having the same wavelength). The other optical signal 18 comprises an optical jamming signal in the form of a pseudo random data stream. The optical jamming signal may take the form of a random data stream. When the fiber is bent to induce leakage of the optical jamming signal for eavesdropping, the monitoring light 20 will also leak. The superposition of the optical signal 18 and the optical jamming signal is detected by the signal receiver, concealing the information. The higher order spatial modes are more sensitive to perturbations to the optical fiber link. When an optical tap is being applied, the tap will couple out light from the higher order spatial modes more strongly than the fundamental spatial mode. Thus the tap may detect the jamming signal rather than the optical signal. Because both the optical signal and the jamming signal have the same or similar wavelength, a wavelength selective filter may not be able to separate optical signal from the jamming signal. Some embodiments have an optical signal 18 that has the same optical wavelength as the optical jamming signal.

Generally, but not necessarily, the monitoring light 20 does not comprise information within the optical signal 18.

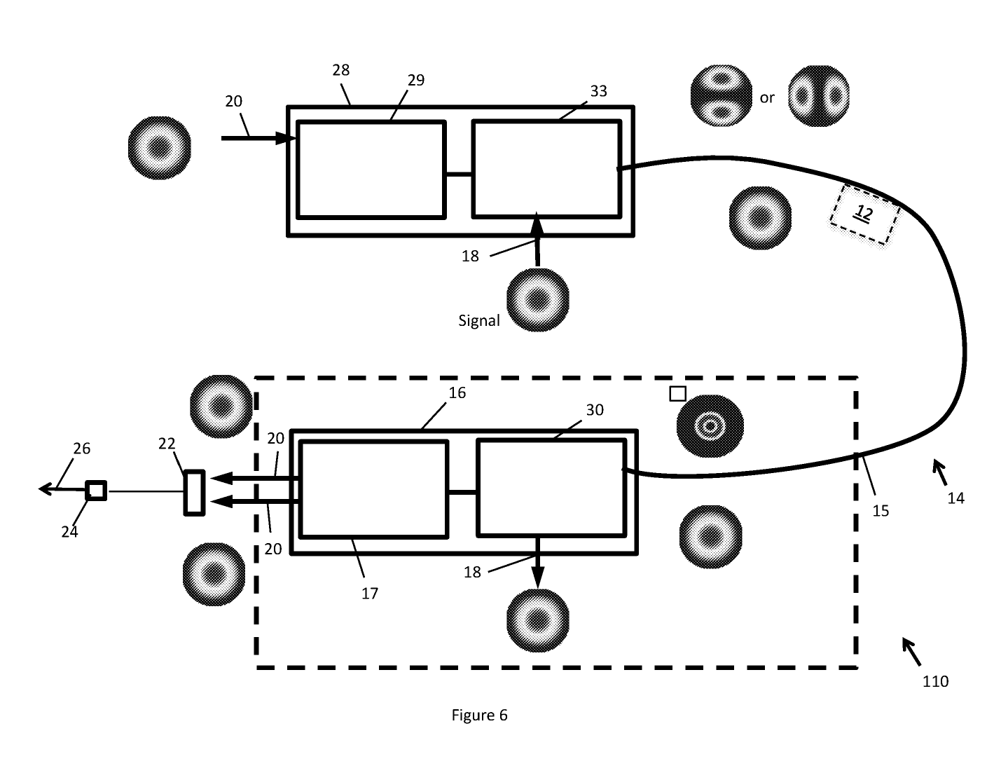

FIG. 6 shows a schematic diagram of another embodiment of a system 110 for detecting the installation of an optical tap 12 on an optical fiber link 15, where parts having similar and/or identical form and/or function to those of FIGS. 3 to 5 are similarly numbered. The de-multiplexer 16 comprises a spatial mode de-multiplexer 17 and a wavelength division de-multiplexer 30 configured for isolating the optical signal 18 from the monitoring light 20. The optical signal 18 and the monitoring signal 20 are of different wavelengths, in this example. The multiplexer 28 comprises a spatial mode multiplexer 29 and a wavelength division multiplexer 33 configured for launching into the optical fiber link 14 the optical signal 18 and the monitoring light 20. The wavelength division de-multiplexer 30 is on the photonic chip 32 of the spatial mode de-multiplexer 17, however it may be on a separate photonic chip in another embodiment. The wavelength division de-multiplexer 30 may alternatively be an optical fiber wavelength division de-multiplexer. Similarly, the wavelength division multiplexer 33 may be on the photonic chip 31 of the spatial mode multiplexer 28, or it may be on a separate photonic chip. The wavelength division multiplexer may alternatively be an optical fiber wavelength division multiplexer.

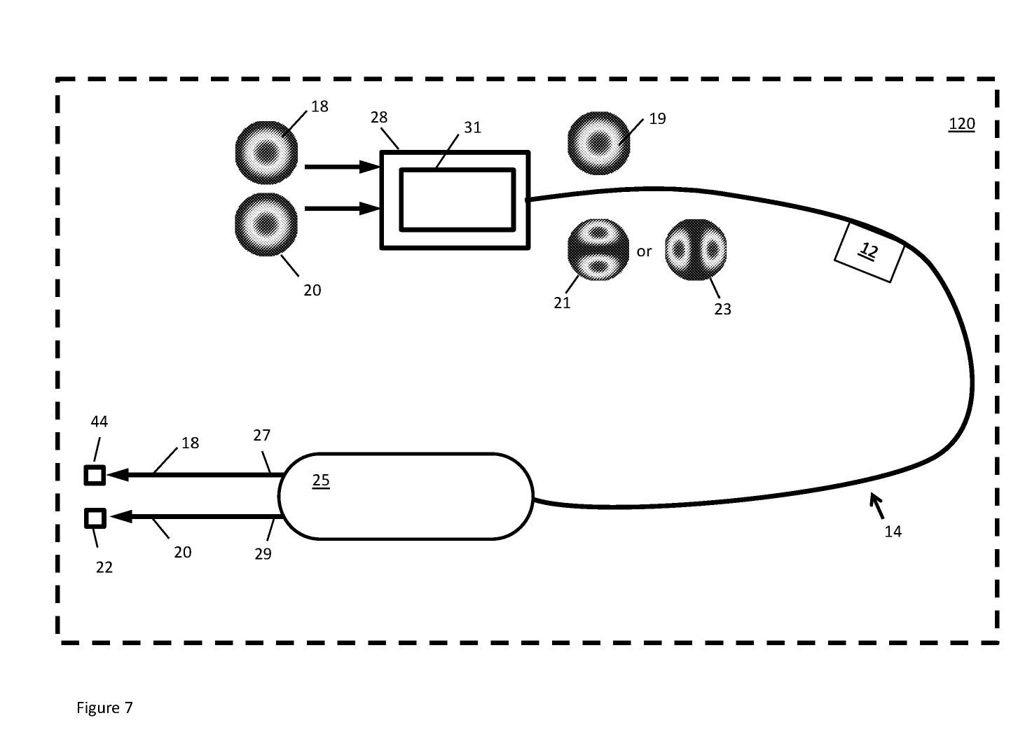

FIG. 7 shows a schematic diagram of another embodiment of a system 120 for detecting the installation of an optical tap 12 on an optical fiber link 14, where parts having similar and/or identical form and/or function to those of FIGS. 3 to 6 are similarly numbered. An optical signal 18 and a monitoring light 20 is launched into a multiplexer 28. The optical signal 18 and the monitoring light have different wavelengths, and so wavelength division multiplexing techniques may be used. The multiplexer 28 couples the optical signal 18 into a first spatial mode 19 in the form of the lowest order spatial mode (LP₀₁), and couples the monitoring signal 20 into a second spatial mode 21, 23 in the form of spatial mode of higher order than that of the first spatial mode (e.g. LP₁₁). The optical signal in the first spatial mode is launched into a corresponding first spatial mode of the optical fiber link 14, which is optically coupled to the multiplexer 28. The monitoring signal in the second spatial mode is launched into a corresponding second spatial mode of the optical fiber link 14, which is optically coupled to the multiplexer 28. The optical power of light in a second spatial mode of the optical fiber link is monitored. In this embodiment, a wavelength division demultiplexer 25 isolates the optical signal 18 and the monitoring light 20. The wavelength division demultiplexer 25 is configured to isolate the optical signal 18 at a first output 27 in the form of an optical signal output fiber, and isolate the optical monitoring light 20 at a second output 29 in the form of a monitoring light optical fiber. The first output 27 and second output 20 may each be in optical communication with respective optical sensors 22, 44. The wavelength division demultiplexer may comprise, for example, an optical fiber wavelength division multiplexer. Installation of the optical tap changes the optical power of the monitoring light in the second spatial mode, which may be detected and a trigger signal generated.

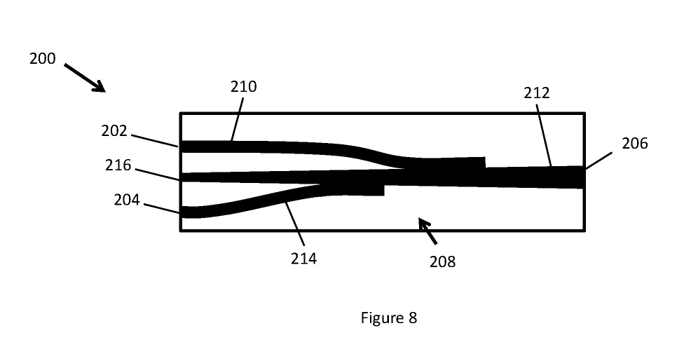

FIG. 8 shows a schematic diagram of an embodiment of a photonic device 200, in the form of a photonic chip, in this embodiment an integrated photonic chip, for multiplexing and de-multiplexing and as such may be either one of the spatial mode multiplexer photonic chip 31 and the spatial mode de-multiplexer photonic chip 32, for example. Table 3 lists specifications of the device used as either a multiplexer 28 or a demultiplexer 16. The photonic device is configured to combine or isolate spatial modes. The individual spatial modes are excited and isolated using the photonic devices 200 for spatial mode multiplexing and spatial mode de-multiplexing. The photonic device 200 has a plurality of optical ports 202, 204, 206, 216. The plurality of optical mode ports may be for optically coupling with a plurality of optical fibers, for example. Each optical port may be for a spatial mode group or a single spatial mode and may take degeneracy into account. The optical port 206 may be for coupling with the optical fiber link 15. The photonic device 200 comprises a waveguide network comprising a coupler 208 comprising a plurality of coupled waveguides in optical communication with the plurality of optical ports 202, 204, 206 and 216. The coupler 208 may be, for example, a mode-selective velocity coupler or photonic lantern. Alternatively, the coupler 208 may be an asymmetric directional coupler. The coupler 208 is configured to couple each spatial mode of the plurality of spatial-mode ports to the port 206, or vice versa. Alternatively, the photonic device may be a fiber device, having for example any suitable structure as described above with respect to photonic chips.

If a waveguide within the photonic chip 200 and the associated optical fiber (that is, the fiber connected to the waveguide's port) have the same numerical aperture, but the optical fiber supports a larger number of modes than the waveguide, then the fiber may be physically tapered down to form a tapered fiber that matches the waveguide. The tapering may improve the coupling efficiency and may provide a mode-filtering effect. Mode-filtering avoids coupling into unwanted higher order modes. Generally, but not necessarily, the taper is between 5 mm and 20 mm in length. If the fiber has a higher numerical aperture than the associated waveguide but they both support the same number of modes, then the core of the fiber may be thermally expanded to reduce its numerical aperture. If the fiber has a higher numerical aperture but supports the same number of modes, then a piece of graded-index fiber or lens may be disposed between the fiber and the associated waveguide. The length of graded-index fiber may be generally 0.25-0.5 times the pitch or the length plus cardinal multiples of 0.5 times the pitch.

Alternatively, a waveguide within the photonic chip 200 may be tapered. The waveguide and fiber core may have similar numerical apertures, but the fiber core may be larger than the waveguide and thus supports a larger number of modes. The waveguide may be tapered to match the fiber core size. The taper may be a dimensional taper and/or an index contrast taper.

A combination of the above described tapering techniques may be used. For example, if the fiber numerical aperture is larger than the waveguide numerical aperture and the fiber supports a large number of modes, then the fiber core may be thermally expanded and the fiber subsequently tapered.

When the photonics device 200 is used as the photonic chip 32 of the spatial mode demultiplexer, light comprising a plurality of spatial modes comprising LP₀₁, LP₁₁ₐ and LP_{11b} spatial modes enter a port 206. The optical signal is in the lowest order LP₀₁ mode, while the monitoring light is in the LP₁₁ₐ and/or the LP_{11b} mode. The photonic chip is configured to isolate the light in each of the plurality of spatial modes 19, 21, 23 at a plurality of ports 202, 204, 216. The port 206 may have attached thereto a connectorized fiber pigtail that is connected with a connectorized end 33 of the optical fiber 15. The connectorized fiber pigtail 15 receives the optical signal 18 and the monitoring light 20 and launches the optical signal 18 and the monitoring light 20 into port 206 and waveguide 212, which is in the form of a major waveguide. The coupler 208 isolates the monitoring light 20 to waveguide 214 or waveguide 210, depending on the spatial mode. Waveguide 210 and 214, which are in the form of a minor waveguide in communication with port 204 and 202, for egress via port 204 or 202. The signal light 18 is retained in waveguide 212, for egress via port 216. Ports 202, 216 and 204 each may have attached thereto a connectorized fiber pigtail for optical connection with sensors, for example. The connectors may comprise, for example, ST, SC, LC, FC, or generally any suitable type of connector.

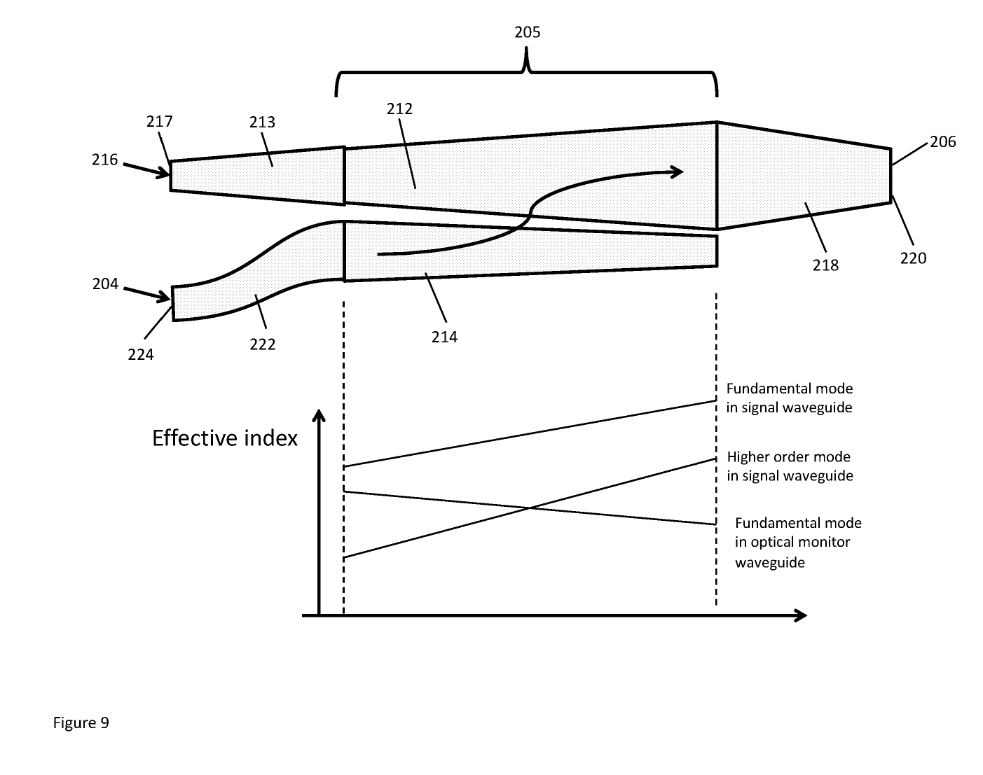

FIG. 9 shows an elevational view of the waveguide network within an example of a photonic chip 31 within an example of a multiplexer 28, where parts similar in form and/or function to those in FIG. 8 are similarly numbered. When used as the photonic chip 31 of the multiplexer 28, the monitoring light 20 is launched into the lowest order optical spatial mode of waveguide 214 via monitoring light input port 204 and the optical signal 18 is launched into the lowest order optical spatial mode of waveguide 212 via optical signal input port 216. The waveguide network is configured to combine the monitoring light 20 and the optical signal 18 by coupling the monitoring light 18 into the signal waveguide 212 while traversing a coupling region 205, for egress via output port 206 of waveguide 212. In the coupling region, the signal waveguide 212 and the monitor waveguide 214 are tapered in opposite directions, although in an alternative embodiment only one of the waveguides 212, 214 may be tapered. The coupling region (that is, the coupler which is in this embodiment the length of the tapers) is in the range of 5 mm to 20 mm long, however in other embodiments it may be between 1 mm and 50 mm long. The port 206 may have attached thereto a connectorized fiber pigtail for attachment to a connectorized end of the optical fiber 15. Ports 216 and 204 may each have attached thereto a connectorized fiber pigtail for optical connection with light sources. The connectorized fiber pigtail attached to port 216 may be connected to an optical signal source operable to generate the optical signal 18, in the form of, for example, a signal modulated laser diode configured to emit light in one of the bands at table 1 or generally any suitable wavelength. The connectorized fiber pigtail attached to port 204 may be connected to a monitoring light source operable to generate the monitoring light 20, in the form of, for example, a laser diode configured to emit light having a wavelength of 980 nm or other suitable wavelength. While in this embodiment the optical signal 18 and the monitor light 20 are co-propagating within the coupling region 205, they may in an alternative embodiment be counter propagating. The port 216 comprises a tapered waveguide 213 configured for matching the optical signal 18 spatial mode dimensions on either side of the optically transparent interface 217 of the port 216. The tapered region 213 is also configured to reject light in spatial modes other than the lowest order spatial mode. The port 204 comprises a tapered waveguide 222 configured for matching the monitoring light 18 spatial mode dimensions on either side of the optically transparent interface 224 of the port 204. The port 206 comprises a tapered region 218 for matching the optical signal 18 spatial mode dimensions on either side of the optically transparent interface 220 of the port 206. The taper may be inwardly or outwardly flaring, depending on for example the optical fiber attached to the port 206. The optical signal 18 is in the lowest order spatial mode at the optically transparent face 220 and the monitoring light 20 is in a higher order mode at the optically transparent face 220. FIG. 9 also shows the effective reactive indices for the lowest order spatial modes in waveguides 212 and 214, and the higher order monitoring light spatial mode in waveguides 212, 214 in the coupling region. The monitoring light 20 in the lowest order optical spatial mode in the waveguide 214 is coupled into the higher order spatial mode of the signal waveguide 212 when the effective refractive indices cross over. Consequently, at port 206 the optical signal 18 is in the lowest order (fundamental) optical spatial mode (LP₀₁) of the waveguide 212 and the monitoring light 20 is in a higher order optical spatial mode (e.g. LP₁₁, LP₂₁) of the waveguide 212. The effective refractive index of the fundamental mode in the optical signal waveguide 212 does not cross the effective refractive index of the fundamental mode in the monitoring light waveguide 214, and so the optical signal 18 is not coupled from the optical signal waveguide 212 into the monitoring light waveguide 214.

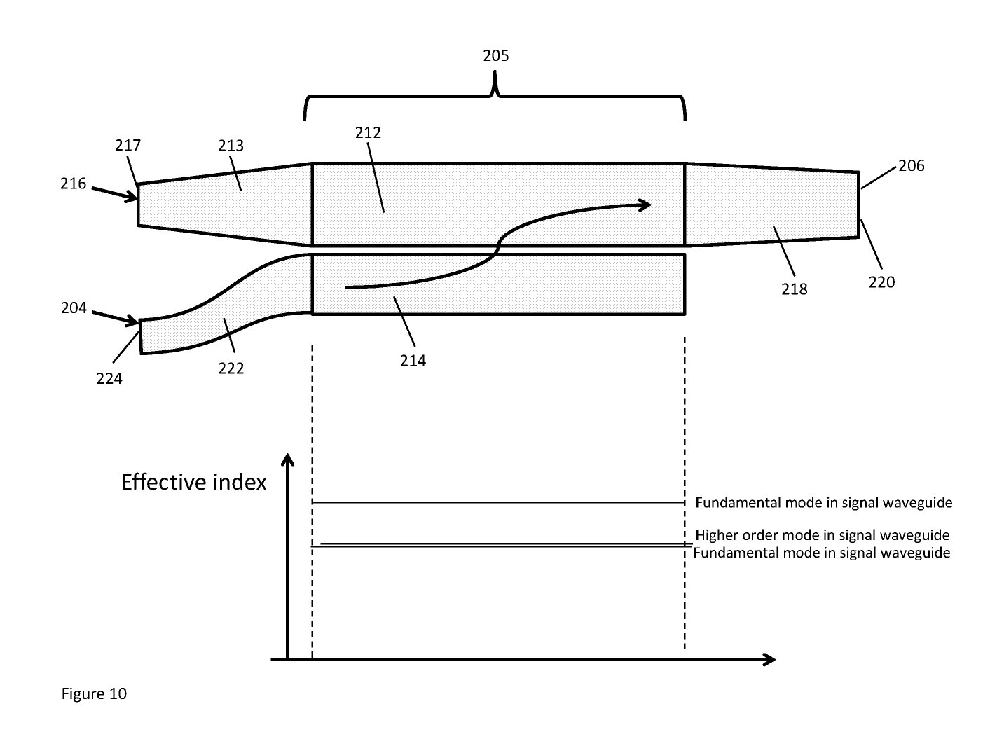

FIG. 10 shows an elevational view of the waveguide network within another example of a photonic chip 31 within another example of a multiplexer 28, where parts similar in form and/or function to those in FIG. 9 are similarly numbered. In this example, however, the waveguides 212,214 are not tapered in the coupling region 205, and coupling occurs along the length of the coupling region. The effective refractive index of the higher order mode in the signal waveguide 212 is substantial the same or the same as the refractive index of the fundamental mode in the monitoring light waveguide 214. The ports may be coupled to optical fibers as described herein.

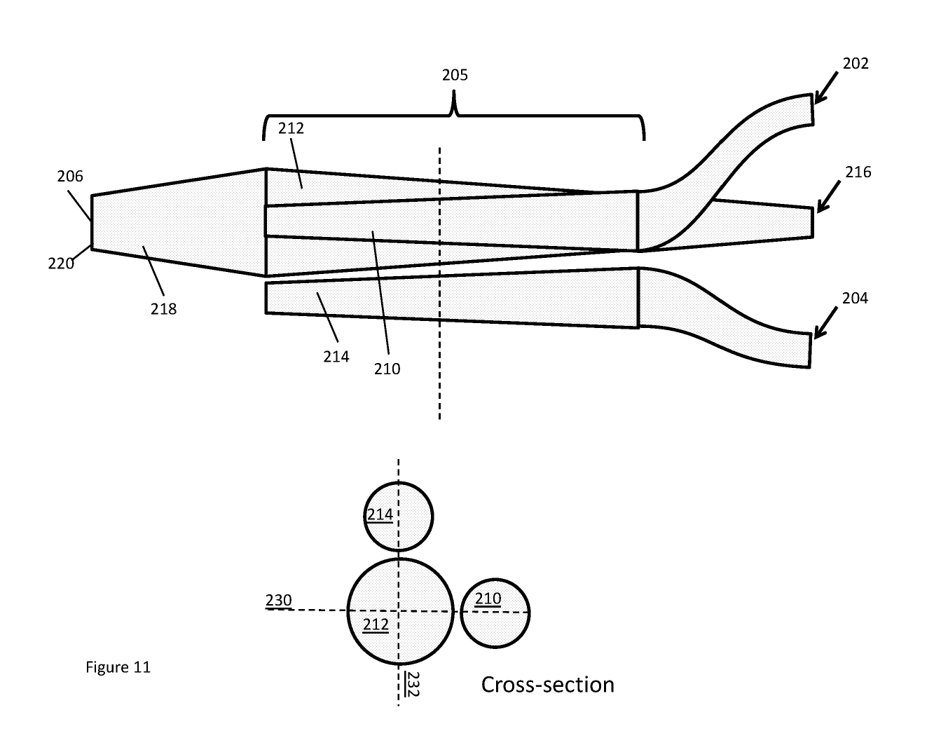

FIG. 11 shows an elevational view of a waveguide network within yet another example of a photonic chip 32 within an example of a demultiplexer 16, where parts similar in form and/or function to those in FIG. 9 are similarly numbered. Port 206 is an optical fiber link 15 port and receives the monitor light 20 in a higher order optical spatial mode, and the signal light in the lowest order optical spatial mode. The length of the coupling region 205 (coupler) is in the range of 5 mm and 20 mm, and in an alternative embodiment in the range of 1 mm to 50 mm. This example demultiplexer both orientation states of a degenerate higher order mode (e.g. LP₁₁ₐ at port 202 and LP_{11b} at port 204, for example). The waveguides in the coupling region 205 are tapered, however they are not in all embodiments. The ports 202, 204, 206, and 216 each comprise a tapered waveguide for mode matching and mode filtering as described. The plurality of waveguides 212, 214, 210 within the coupling region 205 are not centred on a single plane. Waveguides 214 and 212 are centred on a first plane 232 and waveguides 213 and 210 are centred on a second plane. The second plane is in this, but not all, embodiments orthogonal to the first plane. The ports may be coupled to optical fibers as described above.

The optical coupling loss, that is amount of light that is lost between the photonic chip 31,32 and the optical fiber link 15 is relatively low. This reduces the need for high optical powers, optical amplification and unusually sensitive receivers. Optical time delay reflectometry (OTDR) may be used to locate the tap. OTDR is difficult or impossible when high coupling losses are present. The ODTR may be in optical communication with either one of the disclosed multiplexers or de-multiplexers, for example, and may be optically coupled with any one of ports 202, 204 and 216 at the destination 42 or port 206 at the source 40.

The photonic devices disclosed herein may generally comprise an optical material in the form of glass or generally any suitable material. The integrated photonic chips disclosed herein are fabricated by writing a network of waveguides within the optical material using a ultrafast laser in the form of a femtosecond laser. Generally, but not necessarily, the glass is in the form of a glass chip.

TABLE 3
Specification of embodiments of the multiplexer/demultiplexer.

| Specification | Value |
|---|---|
| Loss | <1.5-2 dB for signal port (1550 nm signal), <3-5 dB for |
| | monitor port (700-1000 nm signal), |
| Coupling loss | <1 dB coupling loss between waveguides and fiber, with <0.5 dB |
| | loss with tapers. |
| Mode multiplexing | Fundamental mode excited at the monitor port, the light in the |
| | fundamental mode being coupled into LP₁₁ₐ or LP_{11b} mode |
| | within the photonic device and is subsequently coupled into the |
| | optical fiber link in LP₁₁ₐ or LP_{11b} mode. The de-multiplexer |
| | takes the light present in the LP₁₁ₐ and LP_{11b} and couples to the |
| | fundamental mode LP₀₁ within the photonic device. |
| Physical dimensional of | Wavegudie diameter between 1 and 62.5 um, and in one |
| waveguide and coupling | embodiment between 1 and 15 μm, when the transmission |
| region | optical fiber comprises standard single-mode fiber. |
| Other specifications | Coupling region between 1 mm and 50 mm long, in one |
| | embodiment between 5 mm and 20 mm. |
| | Bend radii of waveguide within chip are >10 mm. |

The laser light is focused using an objective lens into the optical material to generate a focal spot of sufficient intensity to form a plasma resulting in nonlinear optical breakdown of the optical material. The plasma is of a temperature of several thousand degrees Kelvin, and forms a melted ball of optical material having a diameter of around 50 μm. The rapid cooling, compared to the slow cooling when the optical material was first formed, results in a different refractive index at the focal spot. This alters the structure of the glass. The focal spot is translated to form each waveguide 210, 212, 214 in the waveguide network 208. The dimensions and index contrast of the waveguides may be changed by changing the laser pulse energy and the rate at which the focal spot is translated. Laser power and rate of translation parameters may be adjusted for the required degree of waveguide tapering within the photonic device. The waveguides 210, 212, 214 are relatively low loss of <1 dB/cm and exhibit relatively high mode purity, greater than 10 dB, that is at least 90% coupling into the desired higher order mode. The integrated photonic chip 31, 32 comprises waveguides that are tapered. The waveguides have three-dimensional freedom in their location within the integrated photonic chip 31, 32.

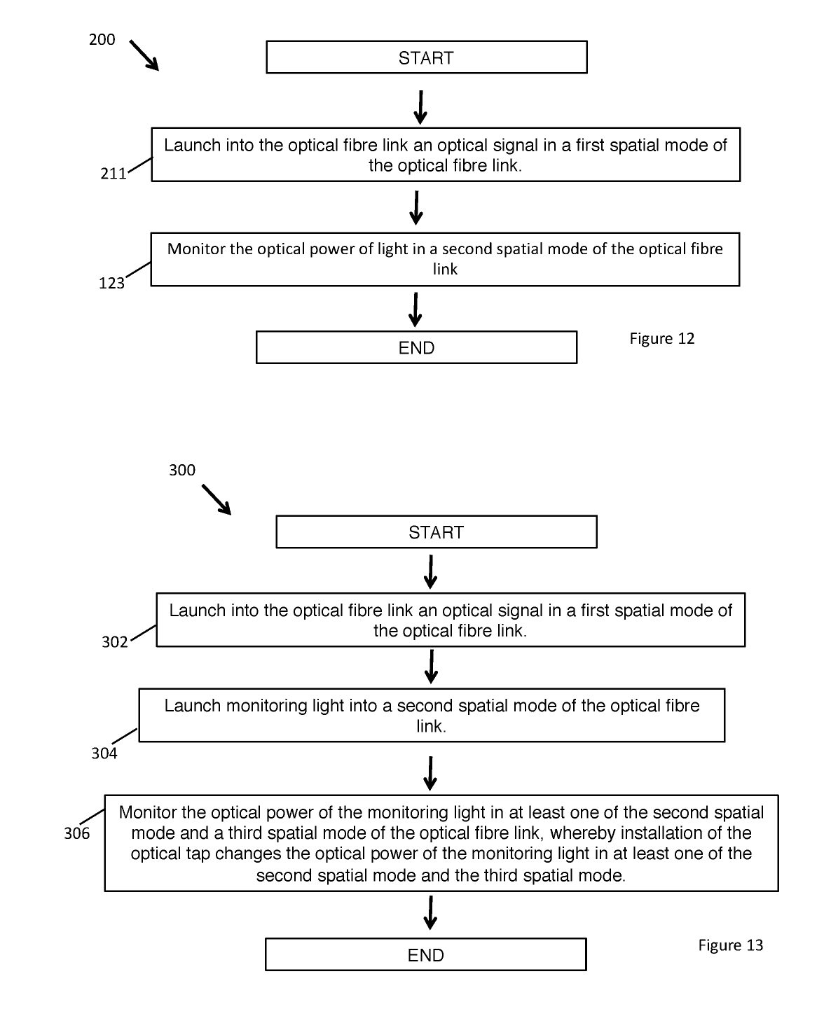

FIG. 12 shows a flow diagram of an embodiment 200 of a method for detecting installation of an optical tap on the optical fiber link 14. The embodiment of the method may be performed using embodiments of systems described herein, for example system 10. A step 211 comprises launching into the optical fiber link an optical signal in a first spatial mode of the optical fiber link. A step 213 comprises monitoring the optical power of light in a second spatial mode of the optical fiber link.

FIG. 13 shows a flow diagram of an embodiment of a method 300 for detecting installation of the optical tap on the optical fiber link 14. The embodiment of the method may be performed using embodiments of systems described herein, for example systems 100 and 110. The embodiment 300 comprises the step 302 of launching into the optical fiber link 14 an optical signal 18 in a first spatial mode of the optical fiber link 14. The embodiment comprises the step 304 of launching monitoring light 20 into a second spatial mode of the optical fiber link 14. The embodiment comprises the step 306 of monitoring the optical power of the monitoring light 20 in at least one of the second spatial mode and the third spatial mode of the optical fiber link 14, whereby installation of the optical tap 12 changes the optical power and/or the proportion of the monitoring light 20 in at least one of the second spatial mode and the third spatial mode. The optical power in only one of the second spatial mode and the third spatial mode may be monitored. Alternatively, the optical power in both of the second spatial mode and the third spatial mode may be monitored.

Optionally, another embodiment of the method comprises the step of generating a trigger signal 26 when the optical power of the monitoring light 20, including a change in the optical power of the monitoring light, in at least one and/or both of the second spatial mode and the third spatial mode satisfies a trigger condition. Other optional steps are described above with respect to the disclosed systems.

The optical fiber link 14 may be, for example, a link in a Local Area Network (LAN), a Wide Area Network (WAN), a long haul networks, a metropolitan area network, a computer interconnect, in a data centre, or generally wherever a secure optical fiber link may be desirable. The optical signals may be encoded using protocols including but not limited to one of the ETHERNET, INFINIBAND, FIBERCHANNEL, PCI-EXPRESS, SONNET, ATM, and TCP/IP, or generally any suitable protocol compliant or not compliant to the OSI model. The optical signal may be either digital or analogue. The optical signal may comprise packets.

Now that embodiments have been described, it will be appreciated that some embodiments may have some of the following advantages:
Optical links carrying sensitive information for defence, defence research, banking and finance, government, diplomatic and generally any facility or service may be monitored for optical tapping.
Monitoring for optical tapping using embodiments described herein may be more cost effective and thus more widely deployed. Optical power sensors are relatively inexpensive.
Embodiments may be more sensitive to optical tapping, enhancing security.
Higher order spatial modes have a radial extent beyond that of the fundamental spatial mode. Consequently, to get to the fundamental mode the higher order modes are disturbed first, so the detection sensitivity may be relatively high.
Common preinstalled optical fiber links may be used.
The monitoring light and the optical signal are distinguished by spatial mode and may additionally be distinguished by optical wavelength, which may assist in their isolation.
Identical photonic chips may be used in a multiplexer and a de-multiplexer, making mass production easier and more cost effective.

Variations and/or modifications may be made to the embodiments described without departing from the spirit or ambit of the invention. The optical fiber link may comprise multimode optical fiber, for example optical fiber that is multimoded at the optical signal wavelength. The optical signal may not be in the fundamental mode. The multimode fiber may not be circularly symmetric, but may be elliptical or square in cross section, for example. The multimode fiber may be a step index, graded index, or a more complex index shape. The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1-55. (canceled)

56. A system for detecting the installation of an optical tap on an optical fiber link, the system comprising:
a multiplexer optically coupled to the optical fiber link and configured for launching an optical signal into a first spatial mode of the optical fiber link and launching a light into a second spatial mode of the optical fiber link;
a de-multiplexer comprising a photonics chip and optically coupled to the optical fiber link and configured to: (a) isolate an optical signal in the first spatial mode of the optical fiber link, and (b) isolate the light in a second spatial mode of the optical fiber link;
an optical sensor optically coupled to the de-multiplexer to measure the optical power of the light in the second spatial mode when so isolated; and
a trigger signal generator in information communication with the optical sensor and configured to generate a trigger signal when optical sensor generated information received thereby is indicative of an optical power of the light in the second spatial mode that satisfies a trigger condition.

57. A system defined by claim 56 wherein the mode order of the second spatial mode is greater than the mode order of the first spatial mode.

58. A system defined by claim 56 wherein the first spatial mode has a mode order of 0.

59. A system defined by claim 56 wherein the optical signal has an optical wavelength greater than the optical fiber link's cut-off wavelength.

60. A system defined by claim 56 wherein the light has an optical wavelength less than the optical fiber link's cut-off wavelength.

61. A system defined by claim 56 whereby installation of the optical tap causes a portion of the optical signal in the first spatial mode of the optical fiber link to couple into the second spatial mode of the optical fiber link.

62. A system defined by claim 56 wherein the multiplexer is configured for launching into the optical fiber link the optical signal in only the first spatial mode and launching the light into only the second spatial mode.

63. A system defined by claim 56 wherein the multiplexer comprises a spatial mode multiplexer.

64. A system defined by claim 63 wherein the multiplexer comprises a wavelength division multiplexer operatively coupled to the spatial mode multiplexer.

65. A system defined by claim 64 wherein the optical signal and the light have different optical wavelengths.

66. A system defined by claim 56 wherein the de-multiplexer comprises a spatial mode de-multiplexer.

67. A system defined by claim 56 wherein the de-multiplexer comprises a wavelength division de-multiplexer.

68. A method for detecting the installation of an optical tap on an optical fiber link, the method comprising the steps of:
launching an optical signal in a first spatial mode of the optical fiber link and launching a light into a second spatial mode of the optical fiber link;
isolating an optical signal in the first spatial mode of the optical fiber link using a de-multiplexer comprising a photonics chip, and isolating the light in the second spatial mode of the optical fiber link using the de-multiplexer comprising the photonics chip;
measuring the optical power of the light in the second spatial mode when so isolated; and
generating a trigger signal when the optical power of the light in the second mode so measured satisfies a trigger condition.

69. A method defined by claim 68 wherein the mode order of the second spatial mode of the optical fiber link is greater than the mode order of the first spatial mode.

70. A method defined by claim 68 wherein the first spatial mode has a mode order of 0.

71. A method defined claim 68 wherein the optical signal has an optical wavelength greater that the optical fiber link's cut-off wavelength.

72. A method defined claim 68 wherein the light has an optical wavelength less than the optical fiber link's cut-off wavelength.

73. A method defined by claim 68 whereby installation of the optical tap causes a portion of the optical signal in the first spatial mode of the optical fiber link to couple into the second spatial mode the optical fiber link.

74. A method defined by claim 68 wherein the step of the launching the optical signal comprises launching the optical signal only into the first spatial mode of the optical fiber link.
